(19) United States
(12) Patent Application Publication
(10) Pub. No.: US 2020/0189778 A1
(43) Pub. Date: Jun. 18, 2020

(54) DISPENSING APPARATUS FOR PACKAGING A MATERIAL

(71) Applicant: Vumos Oy, Kajaani (FI)

(72) Inventors: Jarkko TERVONEN, Kajaani (FI); Terje UURTOMIES, Kajaani (FI)

(73) Assignee: Vumos Oy, Kajaani (FI)

(21) Appl. No.: 16/617,606

(22) PCT Filed: May 30, 2018
(86) PCT No.: PCT/FI2018/050410

§ 371 Date: Nov. 27, 2019

(30) Foreign Application Priority Data
Jun. 1, 2017 (FI) 20175494

(51) Int. Cl. B65B 39/06; B65B 1/32; B65D 88/66; B65D 88/26; B65G 3/04; B65G 65/40

(52) U.S. Cl. CPC B65B 39/06; B65B 1/32; B65G 65/40; B65D 88/26; B65G 3/04; B65D 88/66

(57) ABSTRACT

The invention relates to a dispensing apparatus for packaging a material, wherein the dispensing apparatus comprises a vertical and downwardly tapering hopper element (1) in which the material being dispensed is arranged, comprising more than two side walls with corners therebetween, at least two elongated plate-shaped parts (4) attached substantially horizontally in connection with at least two side walls of the hopper element so as to extend from one corner of the hopper element to another, and a dispensing element (2, 3) arranged at the tapering end of the hopper element, through which dispensing element the material is dispensed, and at least one vibrator arranged in connection with the hopper element (1) to provide vibration of the hopper element via the elongated plate-shaped part (4) to the side walls of the hopper element. Further, the invention relates to the use of the apparatus.

### FIELD OF THE INVENTION

The invention relates to a dispensing apparatus for packaging a material as defined in claim 1, and to the use defined in claim 14.

### BACKGROUND OF THE INVENTION

Various sacking devices for packaging different types of materials by sacking are known in the prior art. In some materials, their internal friction changes under pressure due to the moisture contained in the material, causing compaction, sticking and bridging of the material in the sacking device. This renders packaging of the materials difficult.

### OBJECT OF THE INVENTION

The object of the invention is to disclose a new apparatus for packaging a material. A further object of the invention is to disclose an apparatus to facilitate handling and packaging of unwieldy materials, such as sticky materials and precipitate.

### SUMMARY OF THE INVENTION

The dispensing apparatus according to the invention is characterized by the features set forth in the claims.

The dispensing apparatus comprises at least a vertical and downwardly tapering hopper element in which the material being dispensed is arranged, comprising more than two side walls with corners therebetween, at least two elongated plate-shaped parts attached substantially horizontally in connection with at least two side walls of the hopper element, e.g. to the outer surface or alternatively to the inner surface of the side wall, so as to extend substantially from one corner of the hopper element to another, and a dispensing element arranged, such as connected, to the tapering end of the hopper element, through which dispensing element the material is dispensed, preferably from the hopper element into a package, and at least one vibrator arranged in connection with the hopper element to provide vibration of the hopper element via the elongated plate-shaped part to the side walls of the hopper element. The apparatus may be used for handling unwieldy materials, e.g. sticky materials and precipitate. The apparatus may be used as a material packaging apparatus, e.g. as a sacking apparatus.

In this connection, the material being dispensed refers to any material being dispensed, such as material being sacked, containing one or more material components. The material may comprise unwieldy and sticky materials, such as concentrates, or precipitate, such as precipitate produced when processing nickel, zinc, copper, vanadium or the like. Further, the material may also comprise other material components.

In this connection, the dispensing apparatus refers to any dispensing device, packaging device, filling device, sacking device or other such device or their combinations, by which materials, and also unwieldy materials, may be dispensed and/or packaged into packages, e.g. sacks, boxes or suchlike packages. In one embodiment the dispensing apparatus is a sacking apparatus by means of which the material being dispensed may be dispensed into sacks.

The hopper element may be any appropriate downwardly tapering, such as narrowing, element comprising at least more than two side walls and corners therebetween. In one embodiment the hopper element is a conical, downwardly tapering element. The hopper element is preferably open, or at least partly open at the top. Further, the tapering end of the hopper element at the lower part of the hopper element is preferably open. In one embodiment the tapering end of the hopper element is provided with an element for closing the opening, e.g. a flange, by which the flow of material into the dispensing element may be controlled or stopped.

In one embodiment the hopper element comprises at least three side walls. In one embodiment the hopper element comprises three side walls. In one embodiment the hopper element comprises at least four side walls. In one embodiment the hopper element comprises four side walls. In one embodiment the hopper element comprises five side walls. In one embodiment the hopper element comprises six side walls. In one embodiment the hopper element comprises more than six side walls. The hopper element may be, in cross-section as seen from the top, rectangular, square, triangular, pentagonal, hexagonal, or of another polygonal shape. Preferably the shape, such as taper, as well as the inner surface of the hopper element are selected to be such that the material being dispensed does not stick to the inner surface of the hopper element, but flows in the hopper element smoothly towards the dispensing element.

In one embodiment the inner surfaces of the side walls of the hopper element are provided with an interior coating. In one embodiment the interior coating is formed from a slippery and wear-resistant coating material. In one embodiment the interior coating is formed from a plastic-based material. In one embodiment the interior coating is arranged directly to the inner surface of the side walls. In one embodiment there are coating panels, e.g. polyethylene or polypropylene based panels, attached to the inner surface of the side walls of the hopper element to form the interior coating. The coating panels may be attached by any appropriate manner to the inner walls, e.g. by gluing, bolting, screwing, or by other suitable way. Preferably the coating panels are arranged to be easily replaceable. In one embodiment the coating panels are attached to the inner walls by a bolted joint, such that the coating panels are easily replaceable.

In one embodiment the elongated plate-shaped parts are arranged at least at two side walls of the hopper element, preferably at least at opposite side walls or every other side wall. In one embodiment the apparatus comprises two elongated plate-shaped parts arranged at opposite side walls of the hopper element. In one embodiment the apparatus comprises three elongated plate-shaped parts arranged at least at every other side wall of the hopper element. In one embodiment the hopper element comprises four side walls and corners therebetween, and two elongated plate-shaped parts are arranged at opposite side walls of the hopper element substantially horizontally from one corner to another. In one embodiment the hopper element comprises six side walls and corners therebetween, and three elongated plate-shaped parts are arranged at every other side wall of the hopper element substantially horizontally from one corner to another. When the elongated plate-shaped parts connected with the vibrator or vibrators are arranged at opposite side walls or every other side wall of the hopper element, the force provided by the vibrator or vibrators may be distributed via the corners evenly to the whole area of the side walls of the hopper element. In one preferred embodiment the elongated plate-shaped parts are arranged at the outer surface of the side walls of the hopper element. In one alternative embodiment the elongated plate-shaped parts are arranged at the inner surface of the side walls of the hopper element. The elongated plate-shaped parts may be attached to the side walls of the hopper element by any appropriate manner, e.g. by welding, bolting, screwing or other suitable way.

In one embodiment the elongated plate-shaped part is formed from metal, e.g. steel, composite material or other suitable material that withstands mechanical movement. In one embodiment the elongated plate-shaped part may be an element of any shape or width and any thickness, preferably extending substantially horizontally over one side wall from one corner of the hopper element to the next. In one embodiment the height of the elongated plate-shaped part is 5 30%, in one embodiment 10-25% and in one embodiment 15-23%, of the height of the side wall of the hopper element. In one embodiment the thickness of the elongated plate-shaped part is 3-5 mm.

In one embodiment the outer surface of at least one, preferably more than one of the side walls of the hopper element is provided with at least one support, e.g. a substantially horizontal angle iron, to which a protective element, such as a plate, e.g. a rubber plate, is arrangeable or connectable to prevent the material being dispensed from being scattered outside the hopper element during filling of the hopper element.

In one embodiment the outer surface of at least one, preferably more than one of the side walls of the hopper element is provided with at least one bracket, projection or fastener on which the hopper element rests or by which it is attachable to the dispensing apparatus or to an assembly including the dispensing apparatus, or by which the hopper element is liftable.

In one embodiment the dispensing element comprises at least a reducer element. In one embodiment the dispensing element comprises a reducer element and a dispensing mouth element.

In one embodiment the reducer element is a downwardly tapering element, such as a narrowing element, preferably a conical element. In one embodiment the reducer element is a downwardly tapering, conical element comprising at least four walls with corners therebetween. Preferably the reducer element is arrangeable in the dispensing apparatus between the hopper element and the dispensing mouth element. The reducer element of the dispensing element may be any appropriate device component that is tapering and that is preferably connectable with the dispensing mouth element.

Preferably the reducer element is shaped such that the cross-sectional profile of the upper part of the reducer element corresponds to the cross-sectional profile of the tapering end of the hopper element, e.g. a rectangle or a quadrangle, and the cross-sectional profile of the lower part of the reducer element corresponds to the cross-sectional profile of the dispensing mouth element, e.g. a circle. In one embodiment the dispensing mouth element is shaped to be, in cross-section, substantially circular, or alternatively of a selected polygonal, e.g. tetragonal, pentagonal or hexagonal, shape. In one embodiment the reducer element is shaped so as to taper such that the inner surface of the reducer element has no projections or other such unevenness of the inner surface to provide obstructions of flow of the material stream, and so as to provide a good and smooth flow of the material being dispensed without the material sticking at the inner surface of the reducer element and without bridging. In one embodiment the reducer element is shaped so as to taper such that the angle of its longer walls is 38 degrees and the angle of its shorter walls is 19 degrees, wherein the angles are measured from the vertical line. Further, preferably the connection between the hopper element and the reducer element of the dispensing element is shaped such that the connection is free of corners or notches that would cause bridging of the material. This way, the material being dispensed may be dispensed smoothly from the hopper element into packages through the dispensing element, and bridging may be prevented.

In one embodiment, at least one wall of the reducer element comprises an opening for a sampling device or another monitoring device. The opening may be closable, in case the sampling device or another monitoring device is not used. In one embodiment the lower part of the reducer element is provided with a connecting means, e.g. a collar or a flange, to facilitate connecting the reducer element to the dispensing mouth element.

In one embodiment, in connection with the dispensing mouth of the dispensing mouth element, there is arranged a dispensing valve that is openable and closable and preferably controllable for dispensing the material being dispensed in an appropriate manner and at an appropriate rate. In one embodiment the material being dispensed is dispensed from the dispensing element into a package, such as a sack, a bag, a box, a container or another package.

In one embodiment the material being dispensed is arranged into the hopper element of the dispensing apparatus by feeding it with a feed device. The feed device may have been selected from feed devices known per se, such as a feed screw, a pipe, a scoop, another feed device and their combinations.

The hopper element and the dispensing element may be any suitable elements. The hopper element and the dispensing element may have been formed from any suitable material. In one embodiment the hopper element and the dispensing element are formed from the same material. In one embodiment the hopper element and the dispensing element are formed from different materials. In one embodiment the hopper element and/or the dispensing element are formed from metal, such as steel, or a composite material or their combinations.

In one embodiment the dispensing apparatus comprises one vibrator. In one embodiment the apparatus comprises more than one vibrator. In one embodiment, one vibrator is connected with more than one of the elongated plate-shaped parts. In one embodiment the apparatus comprises an equal number of vibrators and elongated plate-shaped parts for providing the vibration such that one vibrator and one elongated plate-shaped part constitute their own assembly for providing the vibration. The vibrator may be any appropriate vibrator known per se for providing the vibration and for facilitating the flow of the material being dispensed in the dispensing apparatus. In one embodiment the vibrator is a mechanically or electrically adjustable vibrator.

In one embodiment the vibrator is connected with the elongated plate-shaped part. In one embodiment the elongated plate-shaped part comprises at least one connecting piece for connecting the vibrator with the elongated plate-shaped part. In one embodiment the vibrator is attached onto the elongated plate-shaped part by means of the connecting piece. In one embodiment, connecting the vibrator with the elongated plate-shaped part is done by a bolted joint.

In one embodiment the dispensing apparatus comprises at least one sampling element for taking a sample from the material flow. In one embodiment the sampling element is arranged to take samples continuously. In one embodiment the sampling element is a sampling screw. In one embodiment the sampling element is a sampling screw in which the size of the sample is adjustable. In the sampling screw, the size of the sample is adjusted by the rotational speed of the screw, and the sample is conveyed through a tube into a sampling container. Taking the sample from the material flow with the screw ensures that the sample is representative, and the size of the sample is easily adjustable. In one embodiment the sampling screw is arranged substantially centrally in the hopper element. In one embodiment the outlet of the tube of the sampling screw is arranged at the wall of the reducer element.

In one embodiment the dispensing apparatus comprises a holder for supporting the package being filled. The holder may be any holder, hook, hook system or other such means for supporting the package, such as a sack, preferably during filling. In one embodiment the dispensing apparatus comprises a hydraulic transfer device for moving, lifting and lowering the package in connection with the dispensing apparatus, preferably in connection with filling the package.

In one embodiment the dispensing apparatus comprises a weighing device for weighing the package during dispensing, such as filling. In one embodiment the weighing device is arranged to weigh the package in real time. In one embodiment the weighing device is an electronic weighing scale.

In one embodiment the dispensing apparatus comprises a signalling means, e.g. a light beacon, for outputting a signal based on which the material dispensing process may be started or stopped. In one embodiment the signalling means is arranged to cooperate with the weighing device.

In one embodiment the dispensing apparatus is arranged to be batch-operated. In one embodiment the apparatus is arranged to be continuously operated.

In one embodiment the dispensing apparatus is a movable apparatus. In one embodiment the apparatus further comprises a container inside which an assembly formed by the hopper element and the dispensing element is arrangeable. The container may be any container, e.g. a sea container, or a container-type structure that is easily movable. Thus, an easily movable dispensing apparatus may be formed, and it may be brought to the material being packaged.

The dispensing apparatus according to the invention may be used in various applications where it is necessary to handle materials being dispensed, preferably unwieldy and/or sticky materials or precipitates.

The apparatus according to the invention may be used for handling and dispensing industrially produced materials, such as bulk materials. In one embodiment the apparatus according to the invention may be used for handling bulk materials produced in extractive industry, e.g. nickel, zinc, copper and pyrite concentrates and precipitates. Especially the materials produced in concentration processes are often sticky due to moisture and chemical residues.

By means of the invention it is possible to handle and dispense, such as sack, various materials that may also include unwieldy components in terms of dispensing and sacking. With the invention, the force of vibration can be evenly distributed in the hopper element. When the elongated plate-shaped part is arranged to extend, at least in some of the side walls of the hopper element, from one corner to another, the force from the vibrator can be directed to the corners, and thereby distributed evenly in the hopper element, so that the hopper element as a whole will move. Consequently, vibration may be achieved with less force. This way the hopper element is subject to less pulling movement, and for example the interior coatings of the hopper element experience less stress. By means of the invention it is possible to handle and dispense various materials efficiently and economically.

The dispensing apparatus according to the invention may be produced cost-effectively. The device components needed for the apparatus of the invention are simple, and their manufacture and servicing is easy.

### LIST OF FIGURES

FIG. 1 shows one dispensing apparatus according to the invention,

FIGS. 2-3 show some details of the dispensing apparatus illustrated in FIG. 1, and

FIGS. 4a and 4b show one reducer element of the dispensing apparatus.

### DETAILED DESCRIPTION OF THE INVENTION

The invention will now be described by way of detailed examples of its embodiments, with reference to the accompanying figures.

### Example 1

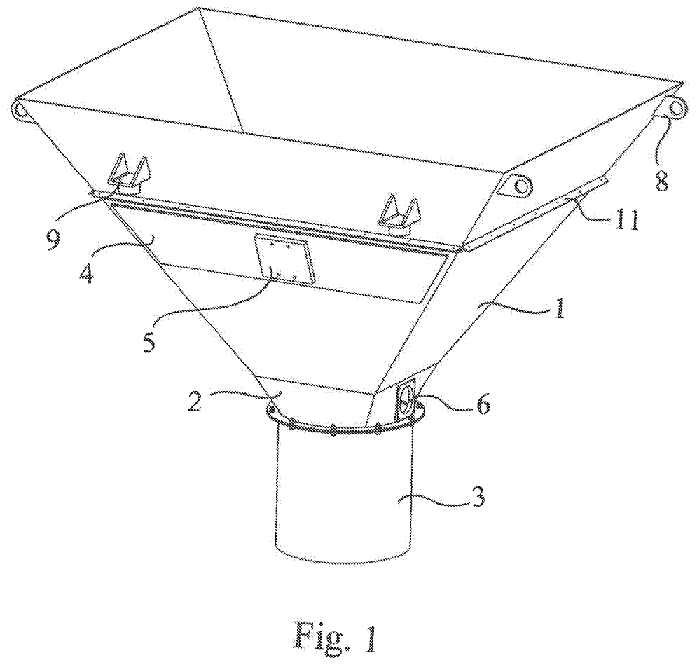

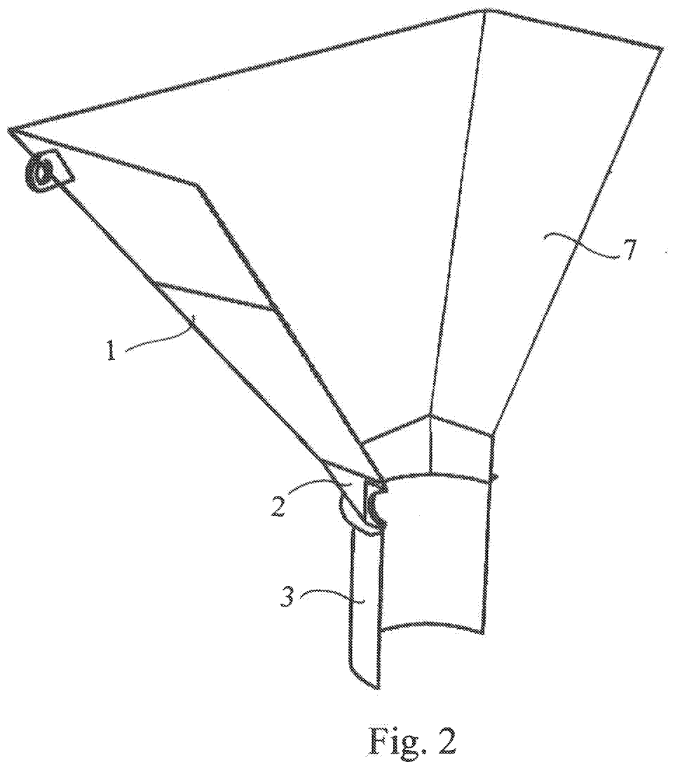

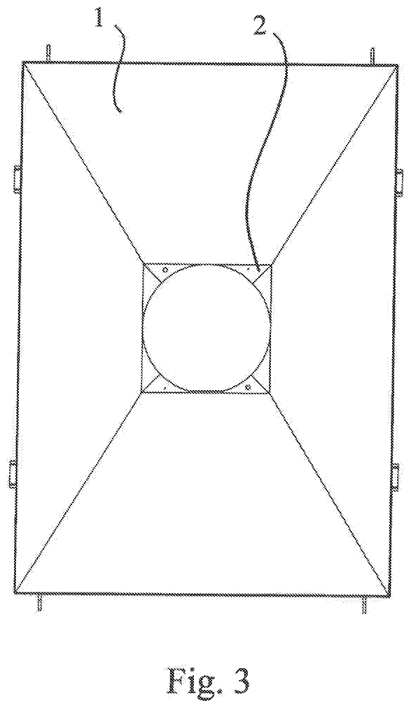

FIGS. 1-3 illustrate a sacking apparatus for packaging unwieldy materials, such as sticky materials and precipitate, into sacks.

The apparatus comprises a vertical and downwardly tapering and conical hopper element (1) in which the material being dispensed is arranged, comprising four side walls with corners therebetween. The cross-section of the hopper element, as seen from the top, is rectangular. Further, the apparatus comprises two elongated plate-shaped parts (4) attached by welding substantially horizontally to the outer surface of two opposite side walls so as to extend on the side wall from one corner of the hopper element to another. Further, the apparatus comprises a dispensing element that comprises a reducer element (2) and a dispensing mouth element (3) and that is connected with the tapering end of the hopper element (1) by means of the reducer element, through which dispensing element the material is dispensed from the hopper element into a sack. Further, the apparatus comprises at least one vibrator connected with the elongated plate-shaped part to provide vibration of the hopper element via the elongated plate-shaped part (4) to the side walls of the hopper element. The vibrator may be any appropriate vibrator known per se, which is not shown in the figure.

Each elongated plate-shaped part (4) comprises at least one connecting piece (5) for connecting the vibrator with the elongated plate-shaped part. In this case, the vibrator is connectable and attachable onto the elongated plate-shaped part (4) by a bolted joint.

Coating panels, e.g. polyethylene or polypropylene based panels, are attached to the inner surface of the side walls of the hopper element (1) to form an interior coating (7).

Because the hopper element (1) comprises four side walls and corners therebetween, as well as two elongated plate-shaped parts (4) arranged at opposite side walls of the hopper element substantially horizontally from one corner to another and connected with the vibrators, the force provided by the vibrators may be distributed via the corners evenly to the whole area of the side walls of the hopper element.

The reducer element (2) is shaped such that the cross-sectional profile of the upper part of the reducer element corresponds to the cross-sectional profile of the tapering end of the hopper element (1), in this case a quadrangle, and the cross-sectional profile of the lower part of the reducer element corresponds to the cross-sectional profile of the dispensing mouth element (3), in this case a circle. The cross-section of the dispensing mouth element (3) is circular.

The hopper element (1), the reducer element (2), the dispensing mouth element (3) and the elongated plate-shaped parts (4) are in this example formed from steel.

The dispensing apparatus comprises a sampling screw in which the size of the sample is adjustable. The sampling screw is arranged substantially centrally in the hopper element (1), and the outlet of the tube of the sampling screw is arranged in an opening (6) at the wall of the reducer element (2).

Further, the outer surface of more than one of the side walls of the hopper element (1) may be provided with a substantially horizontal angle iron (11) to which a protective element, e.g. a rubber plate, is arrangeable and connectable to prevent the material being dispensed from being scattered outside the hopper element during filling of the hopper element.

Further, the outer surface of more than one of the side walls of the hopper element (1) may be provided with projections (8,9) by which the hopper element is liftable and on which the hopper element rests in the dispensing apparatus or in a container housing the dispensing apparatus.

### Example 2

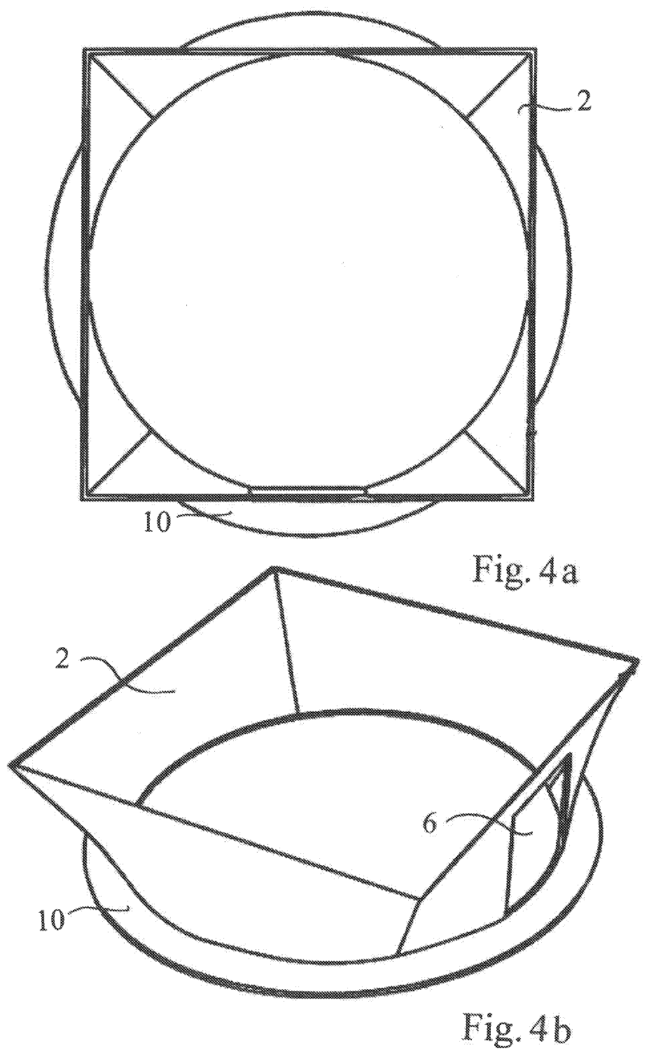

FIGS. 4a and 4b illustrate a reducer element of the dispensing apparatus for preventing sticking and bridging of the material being dispensed.

The reducer element (2) is a downwardly tapering, conical element comprising four walls with corners therebetween. The reducer element (2) is arrangeable in the dispensing apparatus between the hopper element and the dispensing mouth element. The purpose of the reducer element (2) is to be an adapter between two elements with different shapes and to enable the material to continue flowing undisturbed in this intermediate space. The reducer element (2) is shaped such that the cross-sectional profile of the upper part of the reducer element preferably corresponds to the cross-sectional profile of the tapering end of the hopper element, e.g. a rectangle or a quadrangle, and the cross-sectional profile of the lower part of the reducer element corresponds to the cross-sectional profile of the dispensing mouth element, e.g. a circle. In this example the reducer element (2) is at the upper part, in cross-section, quadrangular, and at the lower part circular. Preferably, the reducer element (2) is shaped so as to taper such that the inner surface of the reducer element has no projections or suchlike unevenness on the inner surface to provide obstructions of flow of the material stream, and so as to provide a good and smooth flow of the material being dispensed without the material sticking at the inner surface of the reducer element and without bridging.

At least one wall of the reducer element (2) comprises an opening (6) for a sampling device. The opening (6) may be closable, in case the sampling device is not used.

The lower part of the reducer element is provided with a collar (10) that serves as a connecting means to facilitate connecting the reducer element to the dispensing mouth element.

### Example 3

In this example, unwieldy and sticky material produced in extractive industry was sacked with the sacking apparatus described in Example 1.

The wall thickness of the hopper element was 4 mm, and its material was 5355 steel. The thickness of a plastic throughout-slippery coating panel was 10 mm. The thickness of the elongated plate-shaped part attached by welding to the side wall on the outer side of the hopper element was 10 mm, and its height was ⅕ of the height of the hopper element.

The thickness of the point of attachment of the vibrator was 10 mm+20 mm on the elongated plate-shaped part, and it was fastened by bolts. The technical specifications of the vibrator were: static force 30 kg/mm, 50 Hz, 2.98 kN, 3000 rpm and 1.04/0.6 amplitudes.

The dimensions of the sampling screw were: screw diameter 68 mm, tube inner diameter 72 mm and outer diameter 76.1 mm, screw wave length 68 mm and shaft thickness 30 mm. The measures for the sampling tube hole were: length 0-200 mm and width 72 mm. The screw is powered by an electric motor, and the rotational speed of the screw was 10-100 rpm.

It was noted that sticky material could be handled and sacked easily with the apparatus according to the invention without sticking of the material. It was noted that when using the elongated plate-shaped part according to the invention arranged at the outer wall of the hopper element to extend horizontally from one corner to another, the force of vibration could be distributed in a satisfactory way in the hopper element, and no pulling movement was exerted on the hopper element. As a reference, a shorter plate-shaped part was tested at the wall of the hopper element, whereby it was noted that it does not distribute the force of vibration in the hopper element, and the vibration causes a pulling movement.

The dispensing apparatus according to the invention is suited, through different embodiments, for use in a wide variety of applications for handling a wide variety of materials. Further, the dispensing apparatus according to the invention is suited, through different embodiments, for use in a wide variety of industrial environments.

The invention is not limited only to the examples described above; instead many modifications are possible within the scope of the inventive idea defined by the claims.

1. A dispensing apparatus for packaging a material, wherein the dispensing apparatus comprises:
a vertical and downwardly tapering hopper element in which the material being dispensed is arranged, comprising more than two side walls with corners therebetween;
at least two elongated plate-shaped parts, attached substantially horizontally in connection with at least two side walls of the hopper element so as to extend from one corner of the hopper element to another;
a dispensing element arranged at a tapering end of the hopper element, through which dispensing element the material is dispensed;
at least one vibrator arranged in connection with the hopper element to provide vibration of the hopper element via at least one of the at least two elongated plate-shaped parts to the side walls of the hopper element; and
an interior coating is arranged at an inner surface of the side walls of the hopper element.

2. The apparatus according to claim 1, wherein the hopper element comprises at least four side walls.

3. The apparatus according to claim 1, wherein an interior coating is arranged at the inner surface of the side walls of the hopper element.

4. The apparatus according to claim 3, wherein there are coating panels attached to the inner surface of the side walls of the hopper element to form the interior coating.

5. The apparatus according to claim 1, wherein the dispensing apparatus comprises two elongated plate-shaped parts arranged at opposite side walls of the hopper element.

6. The apparatus according to claim 1, wherein the dispensing apparatus comprises three elongated plate-shaped parts arranged at least at every other side wall of the hopper element.

7. The apparatus according to claim 1, wherein the at least two elongated plate-shaped parts are arranged at an outer surface of the side walls of the hopper element.

8. The apparatus according to claim 1, wherein the dispensing element comprises at least a reducer element.

9. The apparatus according to claim 1, wherein the dispensing element comprises a reducer element and a dispensing mouth element.

10. The apparatus according to claim 8, wherein the reducer element is a downwardly tapering element.

11. The apparatus according to claim 8, wherein at least one wall of the reducer element comprises an opening for a sampling device or another monitoring device.

12. The apparatus according to claim 1, wherein the at least two elongated plate-shaped parts comprise at least one connecting piece for connecting the at least one vibrator with the elongated plate-shaped part.

13. The apparatus according to claim 1, wherein the dispensing apparatus comprises at least one sampling element for taking a sample of the material being dispensed.

14. The apparatus according to claim 1, wherein the apparatus is used for handling and dispensing materials produced in industry and/or materials produced in ex-tractive industry.
